(19) United States
(12) Patent Application Publication
(10) Pub. No.: US 2019/0114728 A1
(43) Pub. Date: Apr. 18, 2019

(54) METHODS, SYSTEMS, AND DEVICES FOR A SERVICE ORIENTED ARCHITECTURE FOR MULTI-FAMILY RENTAL PROPERTY MANAGEMENT

(71) Applicant: Communique' LLC, Wilmington, NC (US)

(72) Inventor: Denver Martell Hollingsworth, JR., Wallace, NC (US)

(21) Appl. No.: 16/162,529

(22) Filed: Oct. 17, 2018

Related U.S. Application Data
(60) Provisional application No. 62/573,792, filed on Oct. 18, 2017.

(51) Int. Cl. G06Q 50/16; G06F 3/0482; G06F 3/16; G10L 15/00

(52) U.S. Cl. CPC G06Q 50/163; G10L 15/00; G06F 3/167; G06F 3/0482

(57) ABSTRACT

A computer implemented method is disclosed for providing rental property owner management and rental property renter management. The method includes identifying interface requirements for a set of services to be implemented between service oriented architecture (SOA) front end components and SOA back end components. At least one of the SOA back end components is configured to communicate with a multi-family rental billing system and at least one other SOA back end component is configured to communicate with a multi-family rental maintenance system. In addition, at least one of the SOA front end components is configured to communicate with a rental unit smart home system. The SOA front end components are operable to be combined with the SOA back end components to form an operable SOA solution.

### CROSS-REFERENCE TO RELATED APPLICATION

This application claims priority to U.S. Provisional Patent Application No. 62/573,792, filed Oct. 18, 2017, and titled “METHODS, SYSTEMS, AND DEVICES FOR A SERVICE ORIENTED ARCHITECTURE FOR MULTI-FAMILY RENTAL PROPERTY MANAGEMENT”, the disclosure of which is incorporated herein by reference in its entirety.

### TECHNICAL FIELD

The present invention relates to service oriented architectures including front end and back end components. More specifically methods, systems, and devices are disclosed for providing rental property owner management and rental property renter management via a service oriented architecture.

### BACKGROUND

The Internet-of-Things (IoT) continues to grow supporting more and more types of devices. The smart home industry has capitalized on this trend by providing an array of wirelessly enabled products. These devices include thermostats, door locks, light switches, air quality detectors, light bulbs, smart electrical outlets, garage door openers, security cameras, and security sensors to name a few. However, this trend has been largely restricted to single family homes and is mostly a do-it-yourself solution for the home owner.

Multiple family rental properties continue to grow as home costs climb with increased real estate market uncertainty. Accordingly, a need exists to provide rental property management and their residents a comprehensive smart home feature set integrated with property management services and software.

### SUMMARY

Disclosed herein are methods, systems, and devices for solving the problem of providing smart home feature sets within property management services and software. More specifically; devices, systems, and methods are disclosed for enabling a middleware solution for the integration of such services.

According to one embodiment, a method is disclosed for providing rental property owner management and rental property renter management on at least one computing device. The method includes identifying interface requirements for a set of services to be implemented between service oriented architecture (SOA) front end components and SOA back end components. At least one of the SOA back end components is configured to communicate with a multi-family rental billing system and at least one other SOA back end component is configured to communicate with a multi-family rental maintenance system. In addition, at least one of the SOA front end components is configured to communicate with a rental unit smart home system. The SOA front end components are operable to be combined with the SOA back end components to form an operable SOA solution.

In some embodiments, at least one of the SOA front end components is configured to communicate with a property manager graphical user interface (GUI). The property manager GUI may be provided by at least one of a smart phone, a tablet, a laptop, and a personal computer. At least one of the SOA front end components may also be configured to communicate with a renter GUI. The renter GUI may be provided by at least one of a smart phone, a tablet, a laptop, and a personal computer. In addition, at least one of the SOA front end components may be configured to communicate with a renter audio user interface (AUI). The renter audio AUI may include a voice recognition user interface and a speech synthesizer.

In some embodiments, the rental unit smart home system may include a smart home hub and at least one smart home device. The smart home device may be an electronic door lock, an electronic light switch, a camera, a motion sensor, a door alarm, a window alarm, a smoke detector, a carbon monoxide detector, a thermostat, a Wi-Fi access point, or the like.

In some embodiments, at least one of the SOA back end components may be configured to retrieve a renter's user profile from a property management database. The renter's user profile may be associated with the rental unit smart home system. The renter's user profile may also be associated with at least one of the multi-family rental billing system and the multi-family rental maintenance system.

In some embodiments, at least one of the SOA back end components may be configured to receive a renter type user profile template from a property management database. The renter type user profile template may be at least one of a single occupant template, a couple occupant template, a family occupant templated, and an occupant with pet template.

In some embodiments, at least one of the SOA front end components may be configured to transmit the renter type user profile template to at least one of the property manager GUI and the renter GUI. In addition, at least one of the SOA front end components may be configured to receive a renter's user profile from at least one of the property manager GUI and the renter GUI.

In some embodiments, at least one of the SOA back end components may be configured to communicate with a rental community commons smart system. The rental community commons smart system may include a public Wi-Fi access point, a public security camera, an electronic gate, and/or the like.

In some embodiments, at least one of the SOA back end components may be configured to communicate with an emergency services system. The emergency services system may be associated with a security service, a police department, a fire department, a medical service, or the like.

In some embodiments, the at least one computing device may be a portion of a networked computing environment. The networked computing environment may be a cloud computing environment and the at least one computing device may be a virtualized server.

In another embodiment, a server is disclosed for providing rental property owner management and rental property renter management. The server includes at least one processor and a memory. The at least one processor is configured for identifying interface requirements for a set of services to be implemented between service oriented architecture (SOA) front end components and SOA back end components. At least one of the SOA back end components is configured to communicate with a multi-family rental billing system and at least one other SOA back end component is configured to communicate with a multi-family rental maintenance system. In addition, at least one of the SOA front end components is configured to communicate with a rental unit smart home system. The SOA front end components are operable to be combined with the SOA back end components to form an operable SOA solution.

In another embodiment, a non-transitory computer readable medium includes a plurality of machine-readable instructions which when executed by one or more processors of a server are adapted to cause the server to perform a method of providing rental property owner management and rental property renter management. The method includes identifying interface requirements for a set of services to be implemented between service oriented architecture (SOA) front end components and SOA back end components. At least one of the SOA back end components is configured to communicate with a multi-family rental billing system and at least one other SOA back end component is configured to communicate with a multi-family rental maintenance system. In addition, at least one of the SOA front end components is configured to communicate with a rental unit smart home system. The SOA front end components are operable to be combined with the SOA back end components to form an operable SOA solution.

In another embodiment, a system is disclosed for providing rental property owner management and rental property renter management. The system includes a server, a first computing device having a property management GUI, and a second computing device having a renter GUI. The server includes a server memory and a server processor. The server processor is configured for identifying interface requirements for a set of services to be implemented between service oriented architecture (SOA) front end components and SOA back end components. At least one of the SOA back end components is configured to communicate with a multi-family rental billing system and at least one other SOA back end component is configured to communicate with a multi-family rental maintenance system. In addition, at least one of the SOA front end components is configured to communicate with a rental unit smart home system. The SOA front end components are operable to be combined with the SOA back end components to form an operable SOA solution. At least of the SOA front end components are configured to communicate with the property manager GUI and at least of the SOA front end components are configured to communicate with the renter GUI.

In other embodiments, the renter GUI may be configured to provide a smart home interface, a rent payment interface, a work order interface, a Wi-Fi management interface, a package delivery interface, a rewards program interface, and/or the like. The property manager GUI may also be configured to provide on boarding functionality for a plurality of renters.

### BRIEF DESCRIPTION OF THE DRAWINGS

The present embodiments are illustrated by way of example and are not intended to be limited by the figures of the accompanying drawings. In the drawings:

FIG. 1 illustrates a system diagram for a service oriented architecture (SOA) providing an interface to SOA back end components and SOE front end components in accordance with embodiments of the present disclosure.

FIG. 2 illustrates a renter graphical user interface (GUI) functionality diagram in accordance with embodiments of the present disclosure.

FIG. 3 illustrates a flowchart for onboarding of residents (i.e. renters) in accordance with embodiments of the present disclosure.

FIG. 4 illustrates a renter notification diagram in accordance with embodiments of the present disclosure.

FIG. 5 illustrates a rental unit smart home system in accordance with embodiments of the present disclosure.

FIG. 6 illustrates a renter GUI for a smart phone example in accordance with embodiments of the present disclosure.

FIG. 7 illustrates a server in accordance with embodiments of the present disclosure.

FIG. 8 illustrates a personal computer in accordance with embodiments of the present disclosure.

FIG. 9 illustrates a smart phone in accordance with embodiments of the present disclosure.

FIG. 10 illustrates another renter GUI example in accordance with embodiments of the present disclosure.

FIGS. 11-21 illustrate property manager GUI examples in accordance with embodiments of the present disclosure.

### DETAILED DESCRIPTION

The following description and drawings are illustrative and are not to be construed as limiting. Numerous specific details are described to provide a thorough understanding of the disclosure. However, in certain instances, well-known or conventional details are not described in order to avoid obscuring the description. References to “one embodiment” or “an embodiment” in the present disclosure can be, but not necessarily are, references to the same embodiment and such references mean at least one of the embodiments.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that same thing can be said in more than one way.

Consequently, alternative language and synonyms may be used for any one or more of the terms discussed herein, nor is any special significance to be placed upon whether or not a term is elaborated or discussed herein. Synonyms for certain terms are provided. A recital of one or more synonyms does not exclude the use of other synonyms. The use of examples anywhere in this specification, including examples of any terms discussed herein, is illustrative only, and is not intended to further limit the scope and meaning of the disclosure or of any exemplified term. Likewise, the disclosure is not limited to various embodiments given in this specification.

Without intent to limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

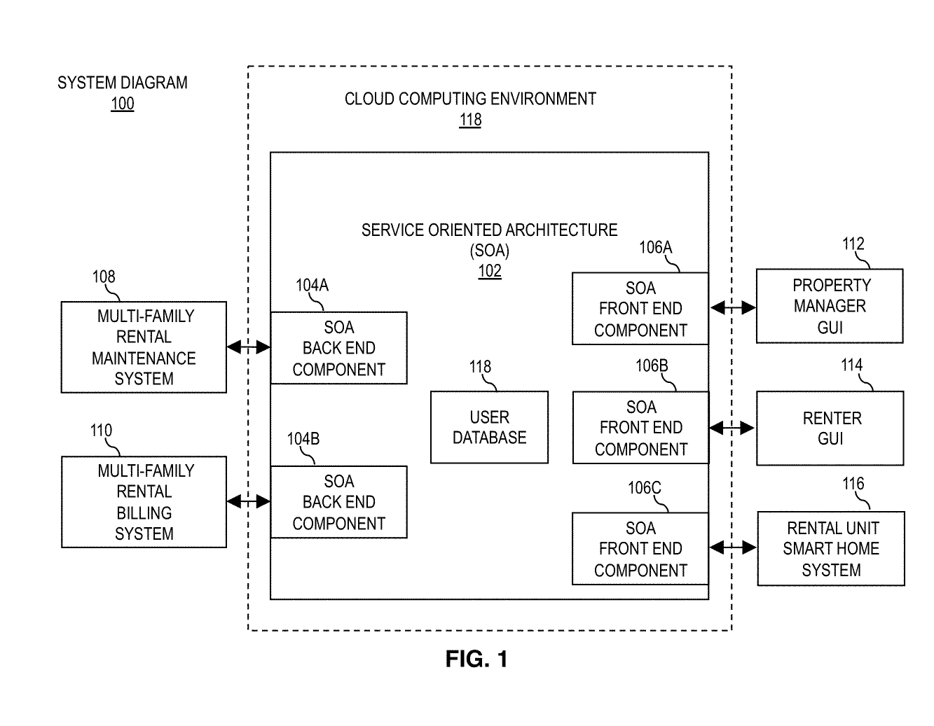

The subject matter disclosed herein relates to middleware (e.g. a service oriented architecture) including front end and back end components. More specifically methods, systems, and devices are disclosed for providing rental property owner management and rental property renter management. A system 100 diagram is shown in FIG. 1 illustrating a service oriented architecture (SOA) 102 in accordance with embodiments of the present disclosure. The SOA 102 includes SOA back end components 104A-B and front end components 106A-C.

The SOA back end component 104A is configured to communicate with at least one multi-family rental billing system 108. The SOA back end component 104B is configured to communicate with at least one multi-family rental maintenance system 110. The SOA back end components 104A-B may be coupled to the multi-family rental billing system 108 and the multi-family rental maintenance system 110 by a combination of the Internet, wide area network (WAN) interfaces, local area network (LAN) interfaces, wired interfaces, wireless interfaces, and/or optical interfaces. In some embodiments, an SOA back end component (not shown in FIG. 1) may be configured to communicate with a rental community commons smart system. The rental community commons smart system may include at least one of a public Wi-Fi access point, a public security camera, and an electronic gate, and/or some combination thereof. An SOA back end components may also be configured to communicate with an emergency services system including a security service, a police department, a fire department, a medical service, and/or some combination thereof.

The front end component 106A is configured to communicate with at least one property manager GUI 112. The front end component 106B is configured to communicate with at least one renter GUI 114. The front end component 106C is configured to communicate with at least one rental unit smart home system 116. The front end components 106A-C may be coupled to the property manager GUI 112, the renter GUI 114, and/or the multi-rental unit smart home system 116 by a combination of the Internet, wide area network (WAN) interfaces, local area network (LAN) interfaces, wired interfaces, wireless interfaces, and/or optical interfaces.

The SOA 102 may also include a user database 118. The user database 118 may be configured to synchronize with at least one of the multi-family rental maintenance system 108, the multi-family rental billing system 110, and the rental unit smart home system 116. In some embodiments, the user database 118 may be an open source database such as the PostgreSQL® database.

The SOA 102 may be implemented on one or more servers. The SOA 102 may include a non-transitory computer readable medium includes a plurality of machine-readable instructions which when executed by one or more processors of the one or more servers are adapted to cause the one or more servers to perform a method of providing rental property owner management and rental property renter management. In a preferred embodiment, the SOA 102 is implemented on a virtual (i.e. software implemented) server in a cloud computing environment 118. An Ubuntu® server 602 may provide the virtual server and may be implemented as a separated operating system (OS) running on one or more physical (i.e. hardware implemented) servers. Any applicable virtual server may by be used for the Ubuntu® Server function. The Ubuntu® server may be implemented within the Microsoft Azure® cloud computing data center environment. In other embodiments, the SOA 102 may be implemented on one or more servers in a networked computing environment located on property owner premises or another data center

The SOA 102 transforms the virtual server or the one or more servers into a machine that solves the problem of providing rental property management and their residents a comprehensive smart home feature set integrated with property management services and software. Specifically, the SOA front end components are operable to be combined with the SOA back end components to form an operable SOA solution.

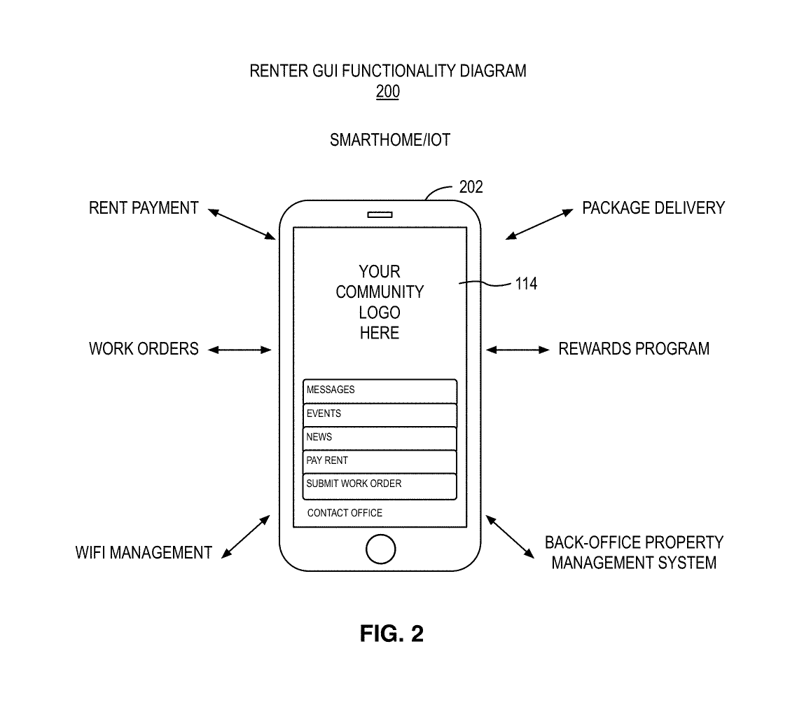

A renter GUI functionality diagram 200 is shown in FIG. 2 in accordance with embodiments of the present disclosure. The renter GUI 114 may provide one or more renter functions including Wi-Fi management, work orders, rent payment, smart home and Internet-of-things (IoT) management, package delivery, and/or rewards programs. These functions may be provided via a back-office property management system (e.g. the multi-family rental maintenance system 108 and/or the multi-family rental billing system 110).

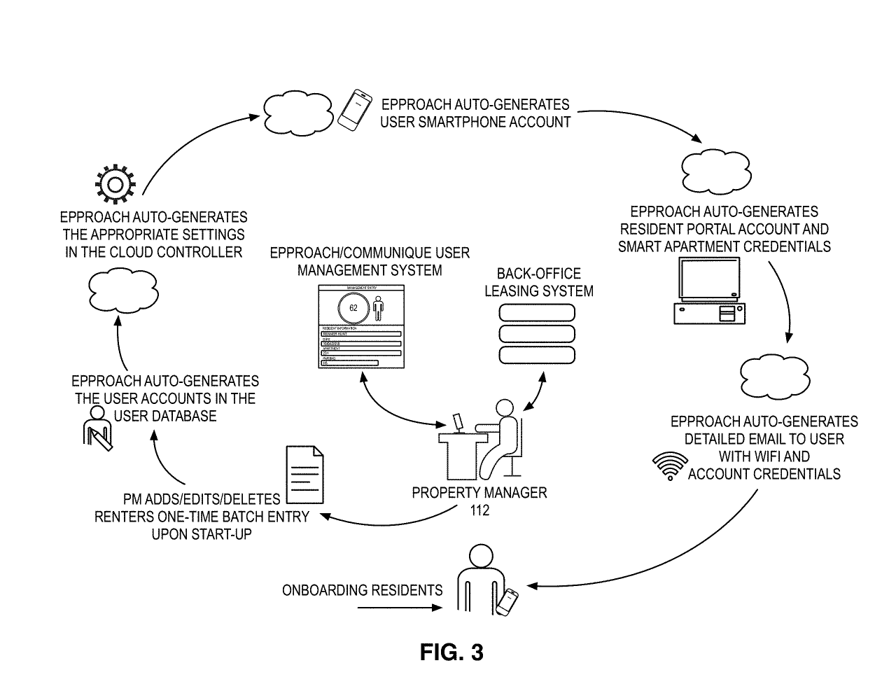

A flowchart 300 is shown FIG. 3 illustrating “onboarding” of residents (i.e. renters) is in accordance with embodiments of the present disclosure. A property manager may onboard renters via the property manager GUI 112. This onboarding may include adds, edits, and deletes of renters. The onboarding may include batch entries of users on start-up of the SOA 102 (e.g. the Epproach/Communique User Management System) and/or start-up or on a reconnection of the property manager GUI 112. For example, information may be provided directly or indirectly by a back-office leasing system.

The SOA 102 may auto generate a user account for a renter in the user database 118. The user account may be auto generated from a renter type user template. The renter type user template may be provided by the user database 118. The SOA 102 may also auto generate user settings for the renter and auto generate a user smartphone account for the renter. The SOA 102 may also auto generate a resident portal account and auto generate smart apartment credentials for use with the rental unit smart home system of FIG. 1. The SOA 102 may also auto generate a detailed email to the renter with the smart apartment credentials. The SOA 102 may also be configured to partially or completely deactivate a resident portal account.

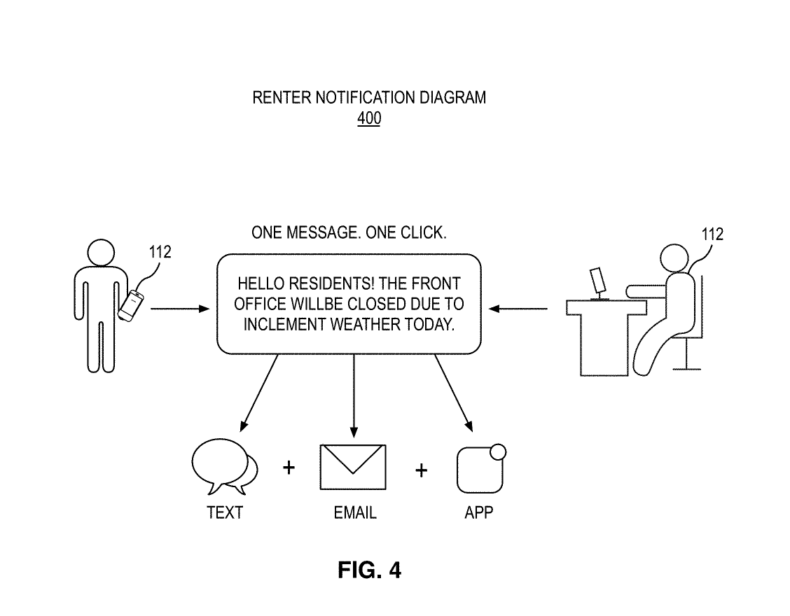

A renter notification diagram 400 is shown in FIG. 4 in accordance with embodiments of the present disclosure. A one click (by the property manager) may auto generate simultaneous notifications to the renter. The simultaneous notification may include an email, a Short Message Service (SMS) text, a notification to a renter specific application for a smartphone, and/or a combination thereof. In some embodiments, a Twilio® server (not shown in FIG. 1) may provide SMS services, Multimedia Messaging Service (MMS) services, Voice over IP (VoIP) services, and/or Web Real-Time Communication (WebRTC) services for renter notifications from the SOA 102.

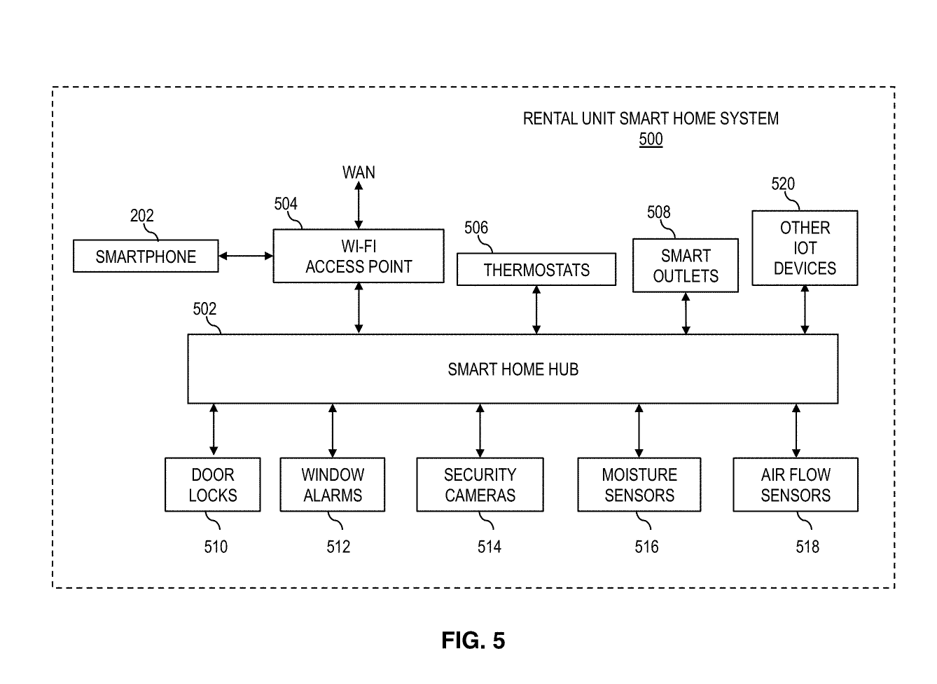

A rental unit smart home system 500 is shown in FIG. 5 in accordance with embodiments of the present disclosure. The rental unit smart home system 500 may include a smart home hub 502. In a preferred embodiment, the smart home hub 502 may be a Wink Hub providing Z-Wave, ZigBee, Lutron Clear Connect, Kidde, Bluetooth, and/or Wi-Fi connectivity to a plurality of smart home devices. In other embodiments, the smart hub 502 may be a Wink Hub 2, a Samsung SmarThings Hub, an Amazon Echo Dot Hub, a Google Home hub, a Icontrol Networks Piper nv hub, a Logitech Harmony Elite hub, a Lowe's Iris Smart Hub, or the like. The smart hub 502 may obtain wide area network (WAN) access via a Wi-Fi access point 504. The smartphone 202 may provide the renter GUI with direct access to the smart home hub 502 or indirect access via the SOA 102. The smart home devices may include door locks 510, window alarms 512, security cameras 514, moisture sensors 516, air flow sensors 518, other IoT devices 520, and/or a combination thereof. The smart home devices may also include speakers and microphones for voice providing at least a portion of a renter audio user interface (AUI). The renter AUI may include a voice recognition user interface and a speech synthesizer.

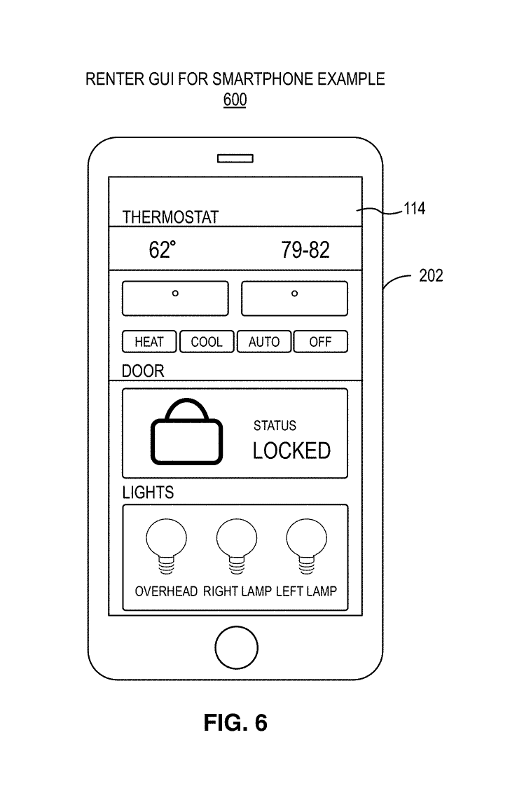

The renter GUI 114 within smart phone example 600 is shown in FIG. 6 in accordance with embodiments of the present disclosure. The renter GUI 114 provides status and control of the rental unit smart home system 500 of FIG. 5. The renter GUI 114 may display an overview, including thermostat, door locks, lights, and other status data. In some embodiments, the SOA 102 may be configured to provide partial or complete control of the renter's account to one or more maintenance personnel associated with the property manager. The partial or complete control may be limited to a specific data and/or time. The SOA 102 may also be configured to send one or more notifications to the renter as disclosed in the discussion of FIG. 4.

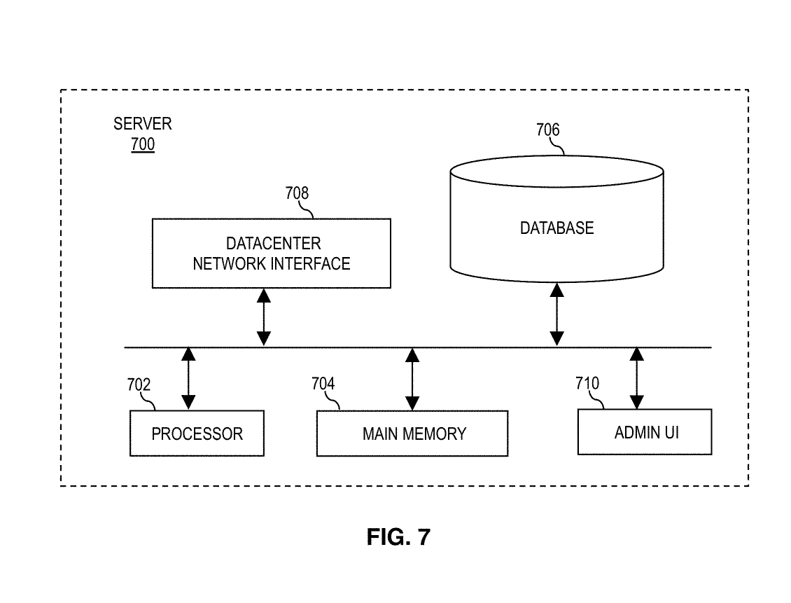

A server 700 is shown in FIG. 7 in accordance with embodiments of the present disclosure. FIG. 7 depicts a block diagram illustrating the server 700 for hosting at least a portion of the SOA 102. The server 700 may include at least one of a processor 702, a main memory 704, a storage memory 706, a datacenter network interface 708, and an administration user interface (UI) 710. The server 700 may be configured to host the Ubuntu server discussed earlier in this disclosure. In some embodiments, the Ubuntu server may be distributed over a plurality of hardware servers using hypervisor technology.

The processor 702 may be a multi-core server class processor suitable for hardware virtualization. The processor may support at least a 64-bit architecture and a single instruction multiple data (SIMD) instruction set. The main memory 704 may include a combination of volatile memory (e.g. random access memory) and non-volatile memory (e.g. flash memory). The database 706 may include one or more hard drives. The database 706 may provide at least a portion of the functionality of the user database 118 of FIG. 3.

The datacenter network interface 708 may provide one or more high-speed communication ports to the data center switches, routers, and/or network storage appliances. The datacenter network interface 708 may include high-speed optical Ethernet, InfiniBand (IB), Internet Small Computer System Interface iSCSI, and/or Fibre Channel interfaces. The administration UI may support local and/or remote configuration of the server 700 by a data center administrator.

The server 700 is transformed to provide the SOA 102 of FIG. 1 for providing rental property management and their residents a comprehensive smart home feature set integrated with property management services and software.

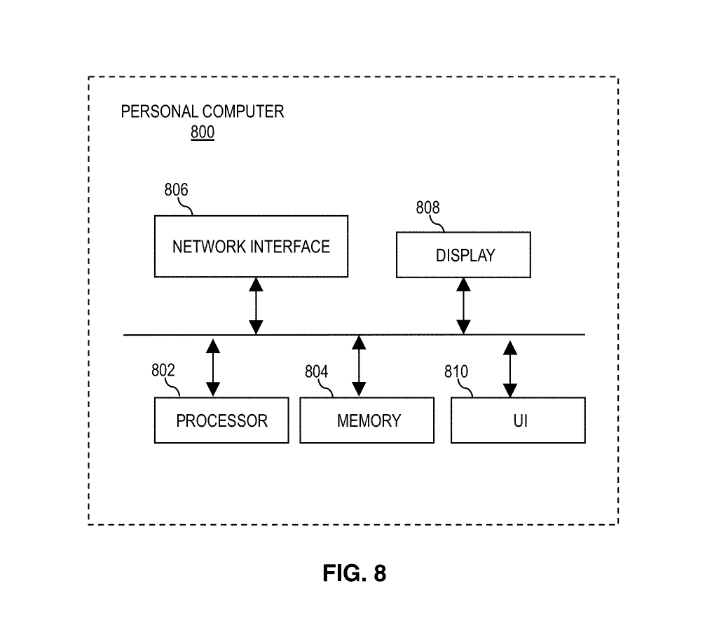

A personal computer 800 is shown in FIG. 8 in accordance with embodiments of the present disclosure. In a preferred embodiment, the personal computer 800 may provide the property manager GUI 112. The property manager GUI 112 may be provided via a dedicated application (i.e. app) running on the personal computer 800. In other embodiments, the property manager GUI 112 may be provided by a web browser running on the personal computer 800. The web browser may be Microsoft Internet Explorer® browser, a Microsoft Edge® browser, an Apple Safari® browser, a Google Chrome® browser, a Mozilla Firefox® browser, an Opera® browser, or the like.

The personal computer 800 may include at least a processor 802, a memory 804, a network interface 806, a display 808, and a user interface (UI) 810. The personal computer 800 may include an operating system to run the web browser of FIG. 6. The operating system (OS) may be a Windows® OS, a Macintosh® OS, a Linux® OS, or the like. The memory may include a combination of volatile memory (e.g. random access memory) and non-volatile memory (e.g. solid state drive and/or hard drives).

The network interface 806 may be a wired Ethernet interface or a Wi-Fi interface. The personal computer 800 may be configured to access remote memory (e.g. network storage and/or cloud storage) via the network interface 806. The display 808 may be an external display (e.g. computer monitor) or internal display (e.g. laptop). The UI 810 may include a keyboard, and a pointing device (e.g. mouse).

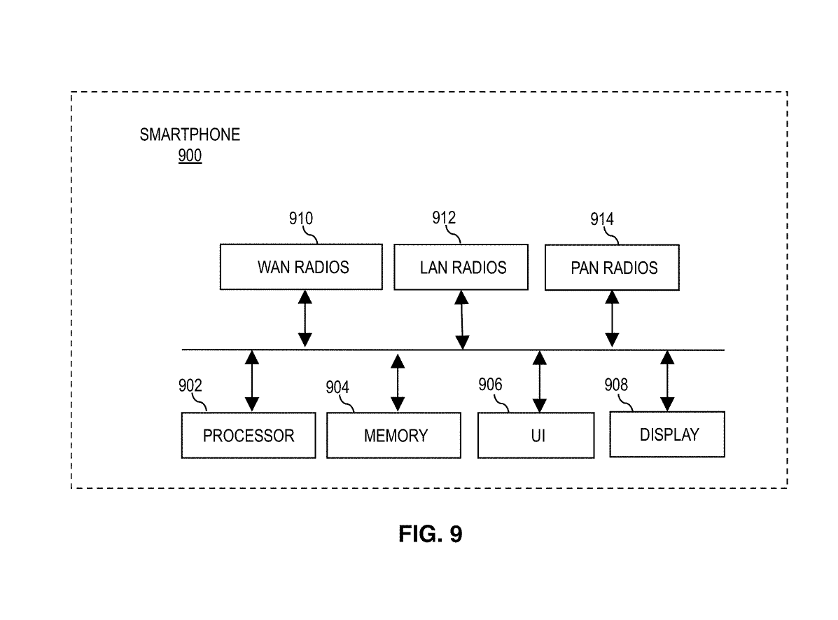

A smart phone 900 is shown in FIG. 9 in accordance with embodiments of the present disclosure. In a preferred embodiment, the smart phone 900 may provide the renter GUI 114. The renter GUI 114 may be provided via a dedicated application (i.e. app) running on the smart phone 900. In other embodiments, the renter GUI 114 may be provided by a mobile web browser running on the smart phone 900.

In other embodiments, the smart phone 900 may provide the property manager GUI 116. The property manager GUI 112 may be provided via a dedicated application (i.e. app) running on the smart phone 900. In other embodiments, the property manager GUI 112 or may be provided by a mobile web browser.

The smartphone 900 may include at least a processor 902, a memory 904, a UI 906, a display 908, WAN radios 910, LAN radios 912, and personal area network (PAN) radios 914. In some embodiments the smartphone 900 may be an iPhone® or an iPad®, using iOS® as an OS). In other embodiments the smartphone 900 may be a mobile terminal including Android® OS, BlackBerry® OS, or Windows Phone® OS.

In some embodiments, the processor 902 may be a mobile processor such as the Qualcomm® Snapdragon™ mobile processor. The memory 904 may include a combination of volatile memory (e.g. random access memory) and non-volatile memory (e.g. flash memory). The memory 904 may be partially integrated with the processor 902. The UI 906 and display 908 may be integrated such as a touchpad display. The WAN radios 910 may include 2G, 3G, 4G, 5G technologies, or a combination thereof. The LAN radios 912 may include Wi-Fi technologies such as 802.11a, 802.11b/g/n, 802.11ac circuitry, or a combination thereof. The PAN radios 912 may include Bluetooth® technologies.

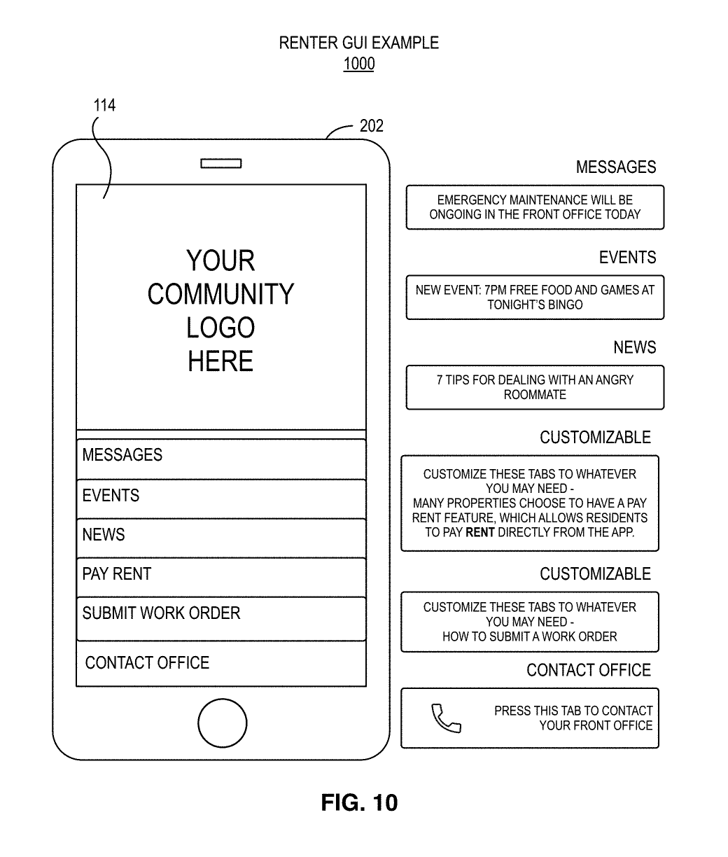

Another renter GUI example 1000 is shown in FIG. 10 in accordance with embodiments of the present disclosure. In this example the renter GUI 114 is configured to display a quick select for messages, events, news, rent payment, work orders, package delivery notifications, office contact, and/or a combination thereof. The GUI 114 may also display a customized community logo or the like.

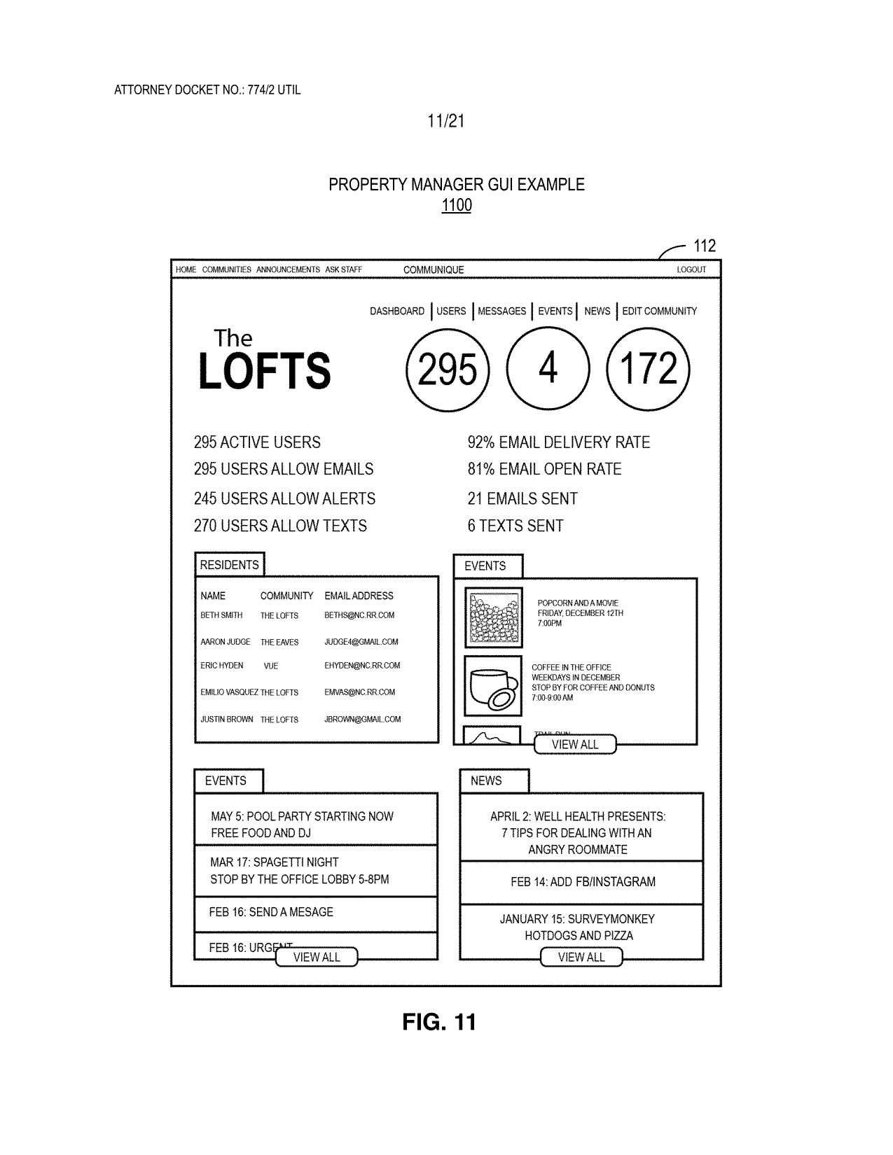

A property manager GUI 1100 is shown in FIG. 11 in accordance with embodiments of the present disclosure. In this example the property manager GUI 112 is configured to display a summary of active users, users allowing emails, users allowing alerts, users allowing text, an email delivery rate for users, an email open rated, emails sent, and texts sent. The property manager GUI 112 is configured to display events, news, residents (i.e. renters) names and contact information, and notification messages from the property manager.

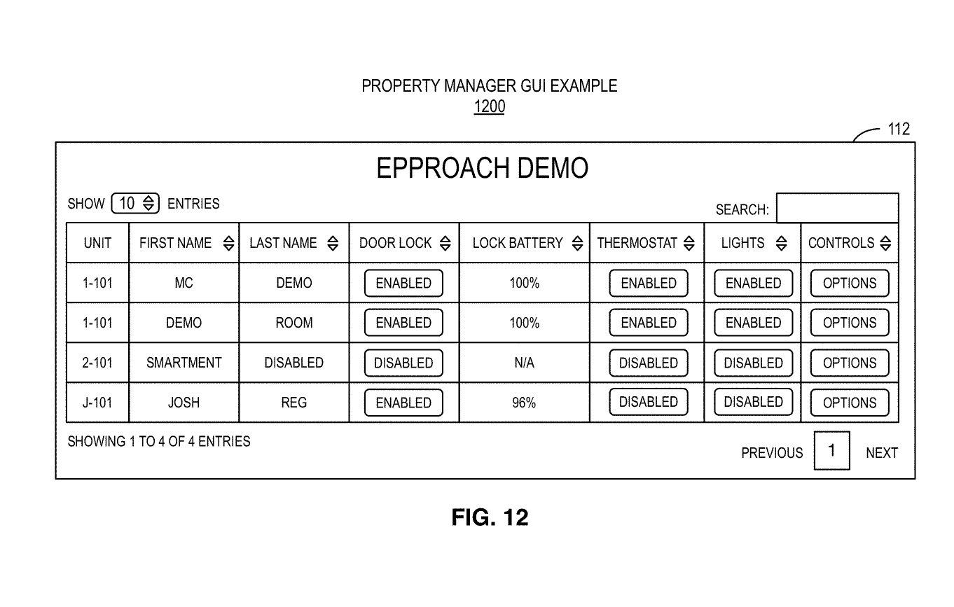

Another property manager GUI example 1200 is shown in FIG. 12 in accordance with embodiments of the present disclosure. In this example the property manager GUI 112 is configured to display a summary of renters' smart home status. The status may include an active on an inactive status for smartlocks, thermostats, lights, and/or the like.

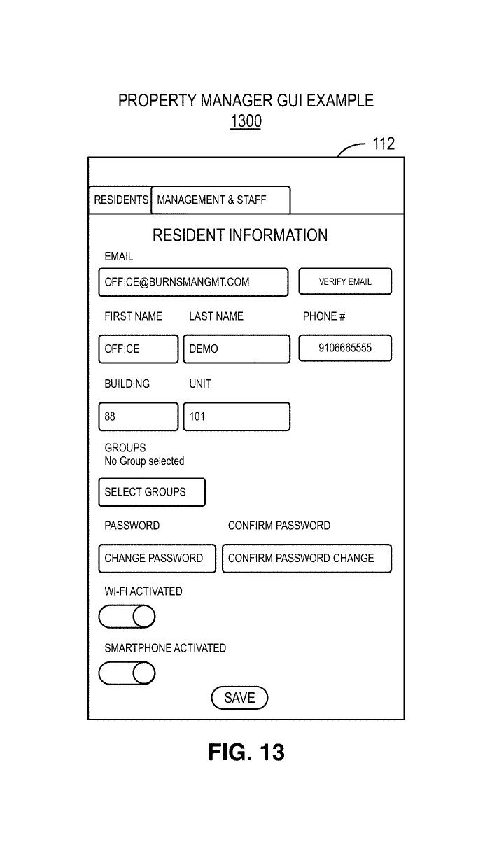

Another property manager GUI example 1300 is shown in FIG. 13 in accordance with embodiments of the present disclosure. In this example the property manager GUI 112 is configured to display residents (i.e. renters) individual contact information, and managers/staff individual contact information. Wi-Fi and Smartphone activation may also be enabled or disable via GUI 112.

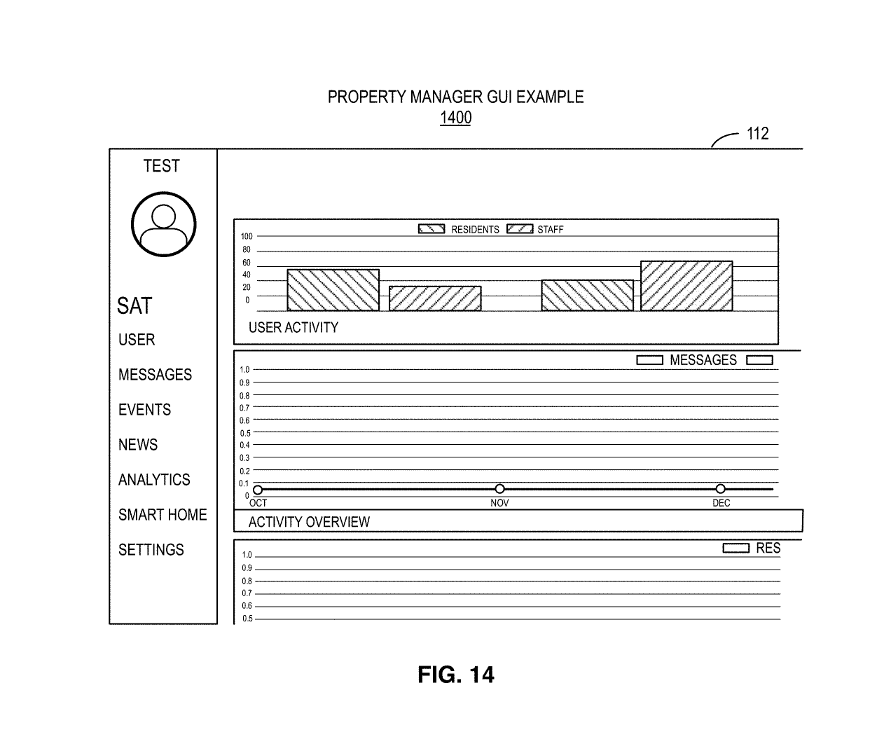

Another property manager GUI example 1400 is shown in FIG. 14 in accordance with embodiments of the present disclosure. In this example the property manager GUI 112 is configured to display a graph of renters' activity over time.

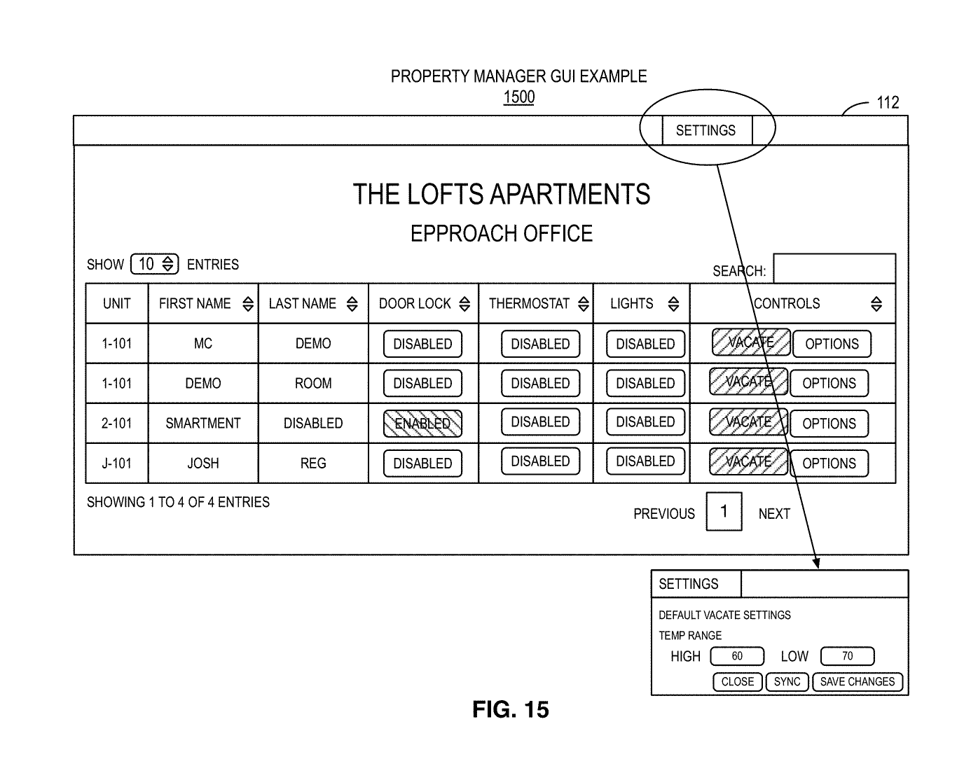

Another property manager GUI example 1500 is shown in FIG. 15 in accordance with embodiments of the present disclosure. In this example the property manager GUI 112 is configured to display a screen to facilitate the property manager to onboard and offboard a plurality of renters.

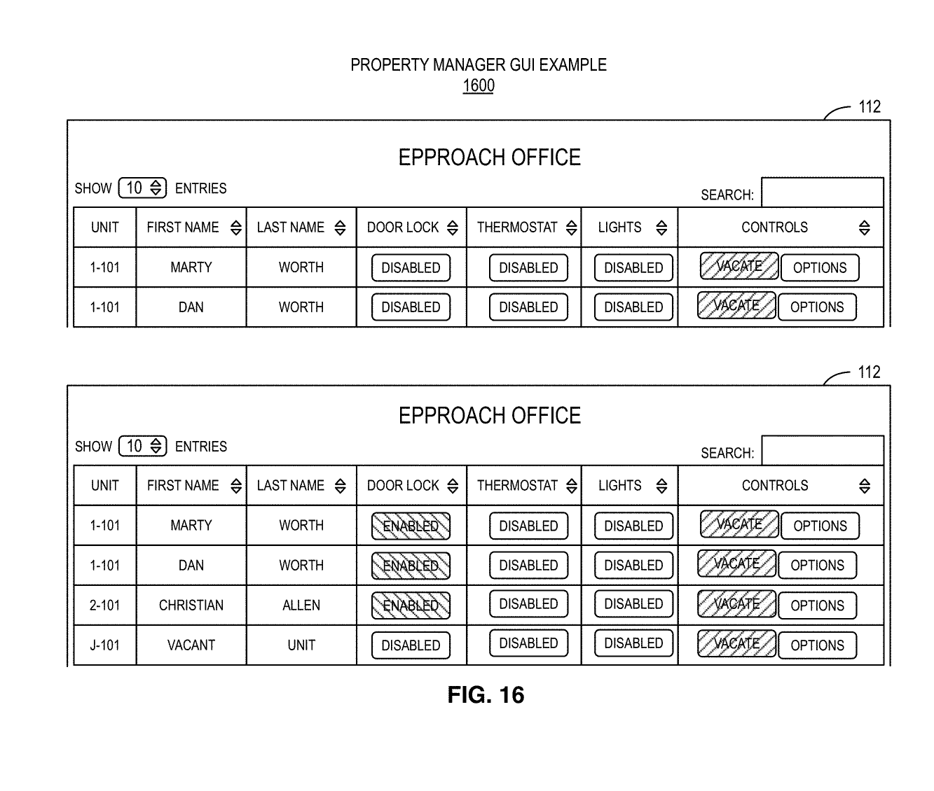

Another property manager GUI example 1600 is shown in FIG. 16 in accordance with embodiments of the present disclosure. In this example the property manager GUI 112 is configured to display an alternate (to FIG. 12) summary of renters' smart home status.

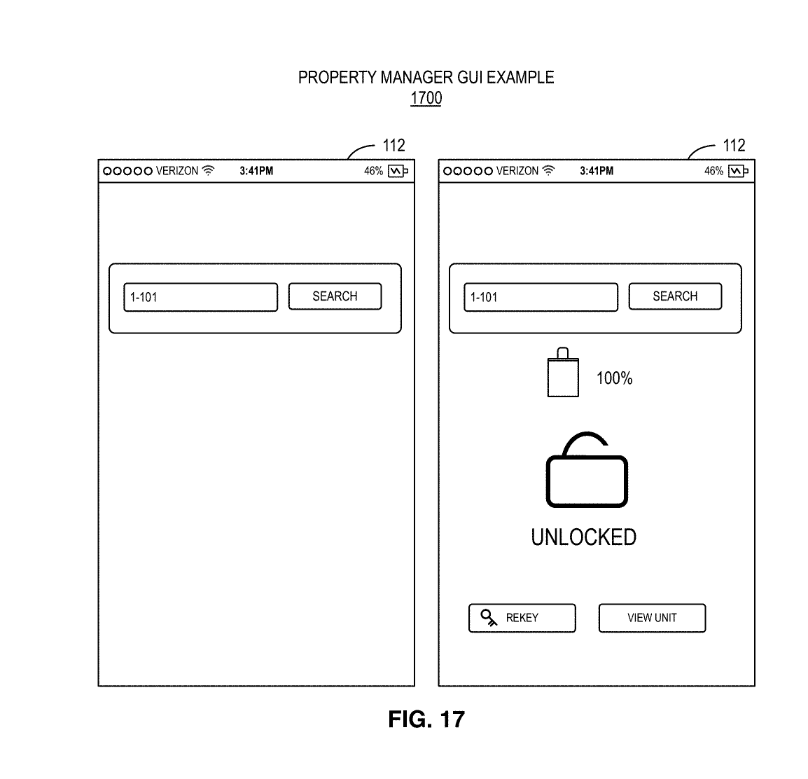

Other property manager GUI examples 1700 are shown in FIG. 17 in accordance with embodiments of the present disclosure. In this example the property manager GUI 112 is configured to display a search function and a rekeying function for a specific rental unit.

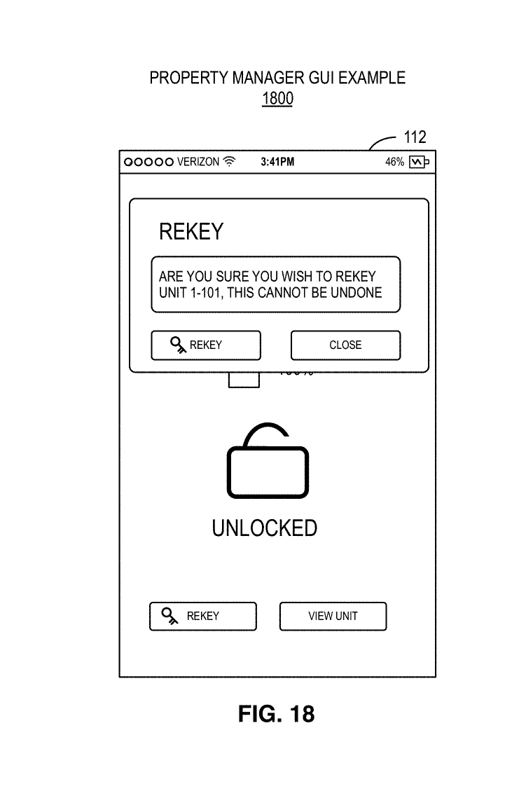

Another property manager GUI example 1800 is shown in FIG. 18 in accordance with embodiments of the present disclosure. In this example the property manager GUI 112 is configured to display a confirmation request for the rekeying function of FIG. 17.

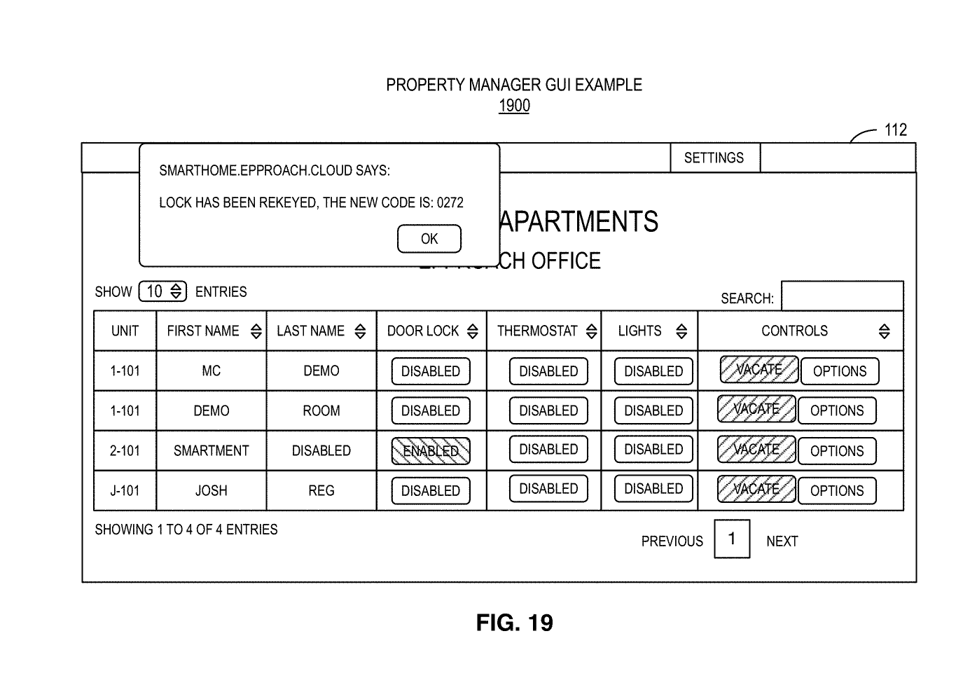

Another property manager GUI example 1900 is shown in FIG. 19 in accordance with embodiments of the present disclosure. In this example the property manager GUI 112 is configured to display a confirmation for the completion of the rekeying function of FIG. 17.

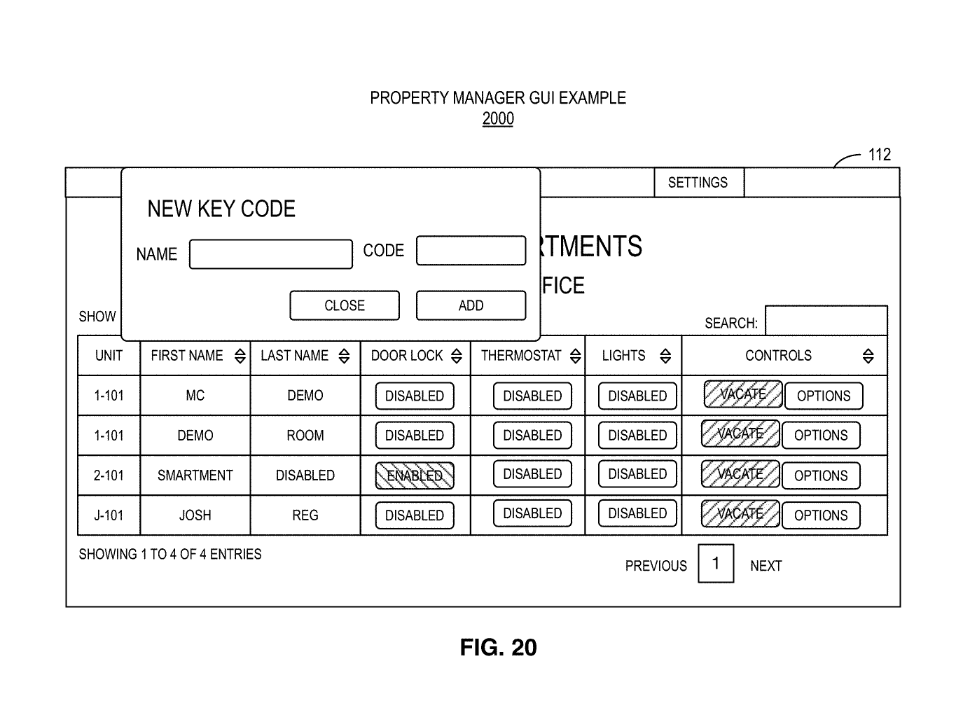

Another property manager GUI example 2000 is shown in FIG. 20 in accordance with embodiments of the present disclosure. In this example the property manager GUI 112 is configured to display adding a key code to a renter name.

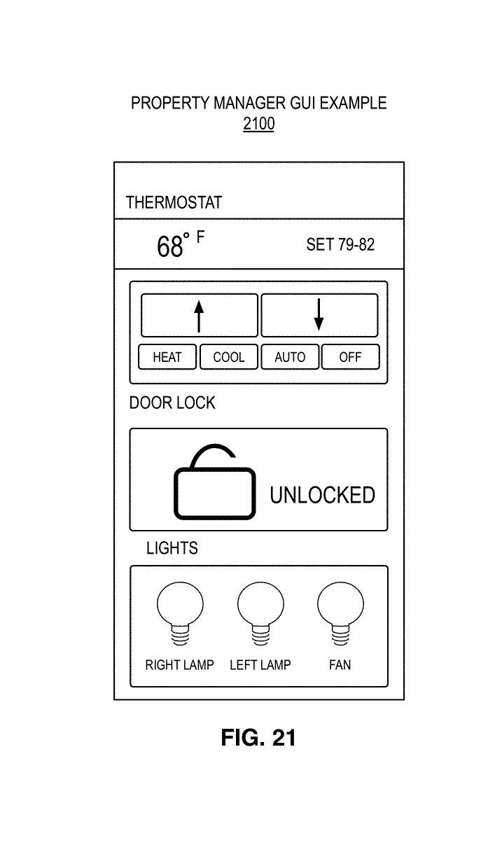

Another property manager GUI example 2100 is shown in FIG. 21 in accordance with embodiments of the present disclosure. In this example the property manager GUI 112 is configured to display a single unit overview.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium (including, but not limited to, non-transitory computer readable storage media). A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including object oriented and/or procedural programming languages. Programming languages may include, but are not limited to: Ruby, JavaScript, Java, Python, Ruby, PHP, C, C++, C#, Objective-C, Go, Scala, Swift, Kotlin, OCaml, or the like. The program code may execute entirely on the user's computer, partly on the user's computer, as a stand-alone software package, partly on the user's computer, and partly on a remote computer or entirely on the remote computer or server. In the latter situation scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method of providing rental property owner management and rental property renter management on at least one computing device, the method comprising:
identifying interface requirements for a set of services to be implemented between service oriented architecture (SOA) front end components and SOA back end components, wherein:
at least one of the SOA back end components is configured to communicate with a multi-family rental billing system;
at least one of the SOA back end components is configured to communicate with a multi-family rental maintenance system;
at least one of the SOA front end components is configured to communicate with a rental unit smart home system; and
the SOA front end components are operable to be combined with the SOA back end components to form an operable SOA solution.

2. The method of claim 1, wherein at least one of the SOA front end components is configured to communicate with a property manager graphical user interface (GUI).

3. The method of claim 2, wherein the property manager GUI is provided by at least one of a smart phone, a tablet, a laptop, and a personal computer.

4. The method of claim 2, wherein at least one of the SOA front end components is configured to communicate with a renter GUI.

5. The method of claim 4, wherein the renter GUI is provided by at least one of a smart phone, a tablet, a laptop, and a personal computer.

6. The method of claim 4, wherein at least one of the SOA front end components is configured to receive a renter's user profile from at least one of the property manager GUI and the renter GUI.

7. The method of claim 4, wherein at least one of the SOA back end components is configured to receive a renter type user profile template from a property management database.

8. The method of claim 7, wherein the renter type user profile template is at least one of a single occupant template, a couple occupant template, a family occupant templated, and an occupant with pet template.

9. The method of claim 7, wherein at least one of the SOA front end components is configured to transmit the renter type user profile template to at least one of the property manager GUI and the renter GUI.

10. The method of claim 1, wherein the rental unit smart home system comprises a smart home hub and a smart home device.

11. The method of claim 10, wherein the smart home device is at least one of an electronic door lock, electronic light switch, a camera, a motion sensor, a door alarm, a window alarm, a smoke detector, carbon monoxide detector, a thermostat, and a Wi-Fi access point.

12. The method of claim 1, wherein at least one of the SOA front end components is configured to communicate with a renter audio user interface (AUI) comprising a voice recognition user interface and a speech synthesizer.

13. The method of claim 1, wherein at least one of the SOA back end components is configured to retrieve a renter's user profile from a property management database, wherein the renter's user profile is associated with the rental unit smart home system.

14. The method of claim 13, wherein the renter's user profile is associated with at least one of the multi-family rental billing system and the multi-family rental maintenance system.

15. The method of claim 1, wherein at least one of the SOA back end components is configured to communicate with a rental community commons smart system.

16. The method of claim 15, wherein the rental community commons smart system comprises at least one of a public Wi-Fi access point, a public security camera, and an electronic gate.

17. The method of claim 1, wherein at least one of the SOA back end components is configured to communicate with an emergency services system comprising at least one of a security service, a police department, a fire department, and a medical service.

18. The method of claim 1, where the at least one computing device is a portion of a networked computing environment.

19. A server for providing rental property owner management and rental property renter management, the server comprising:
a memory; and
at least one processor configured for:
identifying interface requirements for a set of services to be implemented between service oriented architecture (SOA) front end components and SOA back end components, wherein:
at least one of the SOA back end components is configured to communicate with a multi-family rental billing system;
at least one of the SOA back end components is configured to communicate with a multi-family rental maintenance system;
at least one of the SOA front end components is configured to communicate with a rental unit smart home system; and
the SOA front end components are operable to be combined with the SOA back end components to form an operable SOA solution.

20. A non-transitory computer-readable storage medium for providing rental property owner management and rental property renter management, the non-transitory computer-readable storage medium storing instructions to be implemented on at least one computing device including at least one processor, the instructions when executed by the at least one processor cause the at least one computing device to identify interface requirements for a set of services to be implemented between service oriented architecture (SOA) front end components and SOA back end components; wherein:
at least one of the SOA back end components is configured to interface with a multi-family rental billing system;
at least one of the SOA back end components is configured to interface with a multi-family rental maintenance reporting system;
at least one of the SOA front end components is configured to interface with a rental unit smart home system; and
the SOA front end components are operable to be combined with the SOA back end components to form an operable SOA solution.
